(19) United States
(12) Patent Application Publication
(10) Pub. No.: US 2013/0324076 A1
(43) Pub. Date: Dec. 5, 2013

(54) METHOD & SYSTEM FOR CELLULAR NETWORK LOAD BALANCE

(71) Applicant: Eden Rock Communications, LLC, Bothell, WA (US)

(72) Inventor: Jeffrey Paul HARRANG, Sammamish, WA (US)

(21) Appl. No.: 13/910,027

(22) Filed: Jun. 4, 2013

Related U.S. Application Data
(60) Provisional application No. 61/655,375, filed on Jun. 4, 2012.

(51) Int. Cl. H04W 28/08

(52) U.S. Cl. CPC H04W 28/08
USPC 455/405

(57) ABSTRACT

Embodiments of the present invention include a system and methods by which a central or distributed radio resource controller uses current and past measurements of the occupancy and radio channel utilization of clusters of radio-proximate cells to identify when load balancing is performed for a given cluster. A filter may be applied to the data to identify load balancing opportunities. Once identified, the cluster antenna configuration is iteratively adjusted while monitoring radio network performance metrics to minimize the risk of opening coverage holes.

### CROSS-REFERENCES TO RELATED APPLICATIONS

The present invention claims priority to and is a non-provisional of U.S. Application No. 61/655,375, filed Jun. 4, 2012. That application is herein incorporated by reference for all purposes.

### BACKGROUND OF THE INVENTION

Wireless cellular deployments often are deployed in an extended metro or regional coverage area. Often, because of inhomogeneous distributions of mobile user terminals, cells in one part of the network will become overloaded yet nearby cells have surplus radio channel capacity for providing network services. In such scenarios it is useful to reconfigure the cellular network so that some of the users of the overloaded cells have their serving cell changed to nearby cells with surplus through a process known as load balancing.

Although dynamic network load balancing as a concept is well known, current mobile networks are typically statically configured and operated. If persistent overloads in mobile networks are observed, a typical response is to provision new base stations (cell splitting) to increase the area capacity. Real-time or near-real-time dynamic network configuration (aka self-organizing networks) is an evolving trend in the industry.

Network reconfiguration for load balancing often requires adjusting mechanical and electrical antenna parameters and carries the risk, once reconfigured, that a cluster of cells may no longer meet minimum area coverage, mobility or service standards. This may also be referred to as creating a coverage hole. Accordingly, there is a need for a system and method for load balancing to identify the most appropriate cells to load balance while minimizing the risk of opening coverage holes.

### BRIEF SUMMARY OF THE INVENTION

Embodiments of the present invention include a system and methods by which a central or distributed radio resource controller uses current and past measurements of the occupancy and radio channel utilization of clusters of radio-proximate cells to identify when load balancing (LB) is performed for a given cluster. Once identified, the cluster antenna configuration is adjusted while monitoring radio network performance metrics to minimize the risk of opening coverage holes. When the cell occupancy and radio channel utilization imbalance across the cluster is reduced, the cluster may be returned to its original configuration. Various embodiments may be directed to an apparatus, system, and method for identifying a cluster, calculating a load balancing metric, identifying load balancing opportunities, and adjusting antennas.

In one embodiment, a system for determining a load balancing metric for a cluster of cells in a cellular network and performing load balancing using the load balancing metric comprises a processor and a non-transitory computer readable medium with computer executable instructions stored thereon. When executed by the processor, the system defines a cluster of cells including a target cell that is a target for a load balancing operation and a plurality of nearby cells, measures a usage metric for the target cell, measures usage metrics for remaining cells in the cluster, and calculates the load balancing metric using the usage metric value for the target cell and the usage metric values for the remaining cells in the cluster.

In an embodiment, calculating the load balancing metric includes calculating a capacity value for each cell in the cluster including the target cell based on the usage metric for each respective cell, determining a plurality of differences between the capacity value for the target cell and the capacity values for each of the plurality of nearby cells, and calculating a statistical value based on the plurality of differences. The statistical value may be multiplies by a weighting factor normalized relative to a predetermined maximum occupancy. In an embodiment, the capacity value is determined with respect to a profiled peak aggregate throughput of the cell. In some embodiments, calculating the load balancing (LB) metric is performed according to the following equation:

$$LB Metric = \frac{{{\sum }_{i = 1}}^{N} ( {C}_{i} - {C}_{Target} )}{N}$$

in which C_{Target} is the free capacity metric for the target cell, Cᵢ is the free capacity metric for an i-th cell in the cluster not including the target cell, and N is a number of cells in the cluster not including the target cell.

In an embodiment, calculating the load balance includes calculating an average of the capacity metric values for the remaining cells in the cluster and calculating a ratio between the free capacity metric for the target cell and the average of the capacity metric values for the remaining cells. In such an embodiment, the ratio may be scaled to a configured maximum value so that the metric varies over the interval [0, 1].

In an embodiment, the usage metric for the target cell and the usage metrics for the remaining cells in the cluster are separately measured for uplink and downlink transmissions, and the method executed by the processor further comprises comparing the uplink usage metrics to the downlink usage metrics, and using the smaller of the uplink usage metrics and the downlink usage metrics to calculate the load balancing metric.

In an embodiment, the load balancing metric is compared to a threshold value, and a load balancing operation is performed on the target cell when the load balancing metric exceeds the predetermined value. The load balancing metric may be compared to a threshold value during a load balancing operation, and an antenna serving the target cell is returned to an original configuration when the load balancing metric does not exceed the threshold value.

In an embodiment, determining a load balance opportunity includes defining a cluster of cells including a target cell that is a target for a load balancing operation and a plurality of nearby cells, measuring a key performance indicator (KPI) for the target cell, measuring KPIs for remaining cells in the cluster, recording the KPIs in a memory to establish a KPI history for the cluster of cells, applying a pattern filter to the KPI history, calculating a correlation score based on a filter output, and determining whether to perform an antenna adjustment for the target cell based on the correlation score.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as processes. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### BRIEF DESCRIPTION OF THE DRAWINGS

FIG. 1 illustrates a networked computing system according to an embodiment of the present invention.

FIG. 2 illustrates a process according to an embodiment of the present invention.

FIG. 3 illustrates a base station according to an embodiment of the present invention.

FIG. 4 illustrates user equipment according to an embodiment of the present invention.

FIG. 5 illustrates a network resource controller according to an embodiment of the present invention.

FIG. 6 illustrates a method of load balancing according to an embodiment of the present invention.

FIG. 7 illustrates RET adjustments according to an embodiment of the present invention.

FIG. 8 illustrates RAS adjustments according to an embodiment of the present invention.

FIG. 9 illustrates RAB adjustments according to an embodiment of the present invention.

FIG. 10 illustrates a process for determining a cluster according to an embodiment of the present invention.

FIG. 11 illustrates a process for determining a load balancing metric according to an embodiment of the present invention.

FIGS. 12A and 12B illustrate a process for calculating a load balancing score according to an embodiment of the present invention.

FIGS. 13A and 13B illustrate a process for calculating a load balancing score according to an embodiment of the present invention.

FIG. 14 illustrates a process for identifying a load balancing opportunity according to an embodiment of the present invention.

FIG. 15 illustrates a process for identifying a load balancing opportunity using a filter according to an embodiment of the present invention.

FIG. 16 illustrates a diagram of a filter according to an embodiment of the present invention.

FIG. 17 illustrates a process for determining whether to perform load balancing according to an embodiment of the present invention.

FIG. 18 illustrates a process for adjusting an antenna according to an embodiment of the present invention.

FIG. 19 illustrates a process for adjusting an antenna according to an embodiment of the present invention.

### DETAILED DESCRIPTION OF THE INVENTION

A system and method according to embodiments of the present invention may implement various aspects of a load balancing operation. The aspects may include identifying clusters of base stations or cells based on a particular target cell, collecting and evaluating performance metrics, calculating a load balancing metric, evaluating load balancing opportunities, and steering antennas to balance a load.

The following description is an example of how various aspects of the present invention may be implemented. In the example, a mobile network operator observes repeating intervals of cell overload in portions of their network providing service to a collection of mobile user equipment terminals (UEs). Service to UEs in the overloaded cells is poor because the radio resources are shared between UEs and insufficient bandwidth exists to meet expected service performance levels. The operator installs the load balancing system. Once in place, the load balancing system automatically manipulates the cell radio antenna configurations to reduce the frequency and severity of cell overload which in turn improves UE service levels.

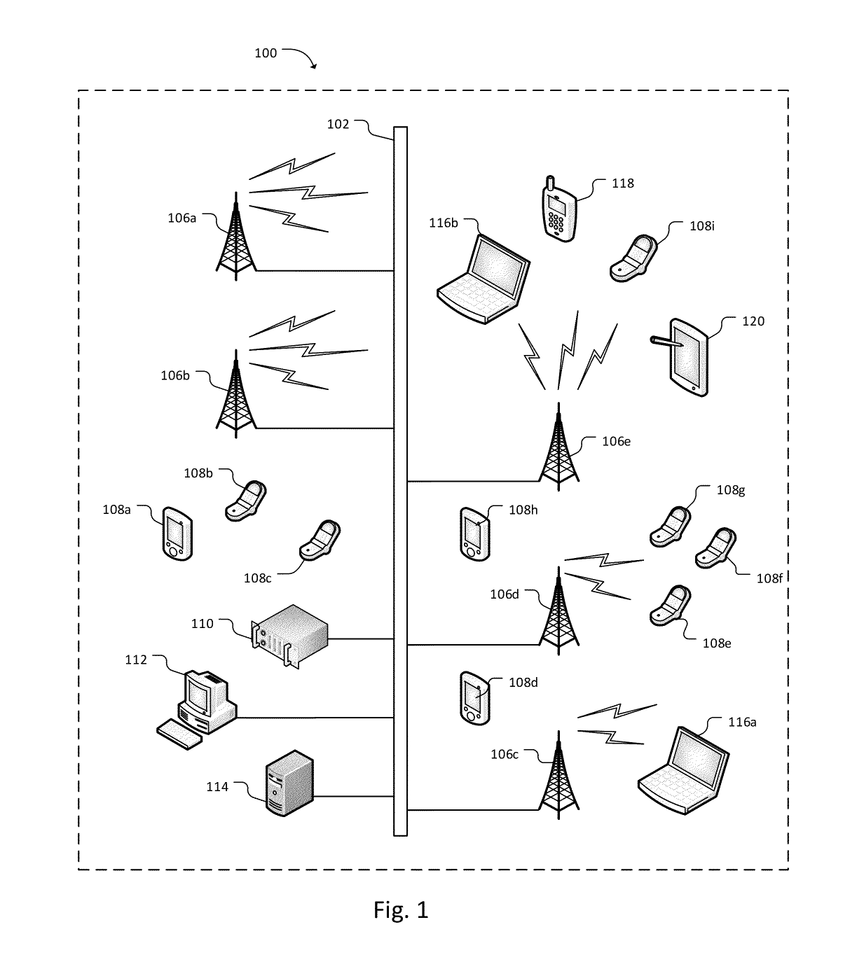

An example of an embodiment of a wireless network system 100 according to an embodiment of the present invention is illustrated in FIG. 1. As depicted, system 100 may include a data communications network 102, one or more network base stations 106a-e, one or more base station antennas 104a-e, one or more network controller devices 110a-c, and one or more User Equipment (UE) 108a-m.

In system 100, the data communications network 102 may include a backhaul portion that can facilitate distributed network communications between any of the network controller devices 110, 112, and 114 and any of the network base stations 106a-e. Any of the network controller devices 110-114 may be Network Resource Controllers (NRCs) or have NRC functionality. Any of the network base stations 106a-e may be NRCs or have NRC functionality that may share overlapping wireless coverage with one or more neighboring base stations within a particular region of the networked computing system 100. The one or more UE 108a-m may include cell phone/PDA devices 108a-i, laptop/netbook computers 108j-k, handheld gaming units 1081, electronic book devices or tablet PCs 108m, and any other type of common portable wireless computing device that may be provided with wireless communications service by any of the network base stations 106a-e.

As would be understood by those skilled in the Art, in most digital communications networks, the backhaul portion of a data communications network 102 may include intermediate links between a backbone of the network which are generally wire line, and sub networks or network base stations 106a-e located at the periphery of the network. For example, cellular user equipment (e.g., any of UE 108a-m) communicating with one or more network base stations 106a-e may constitute a local sub network. The network connection between any of the network base stations 106a-e and the rest of the world may initiate with a link to the backhaul portion of an access provider's communications network 102 (e.g., via a point of presence).

In an embodiment, any of the network controller devices 110-114, and/or network base stations 106a-e may have NRC functionality or be considered as an NRC. An NRC may facilitate functions associated with various embodiments of the invention. An NRC is a physical entity that may include software components. In accordance with an embodiment of the invention, an NRC may be a physical device, such as one of network controller devices 110-114 or one of network base stations 106a-e. In yet another embodiment, an NRC that performs a particular function of the invention may be a logical software-based entity that can be stored in the volatile or non-volatile memory or memories, or more generally in a non-transitory computer readable medium, of a physical device such as any of network controller devices 110-114 or of network base stations 106a-e.

In accordance with various embodiments of the invention, an NRC has presence and functionality that may be defined by the processes it is capable of carrying out. Accordingly, the conceptual entity that is the NRC may be generally defined by its role in performing processes associated with embodiments of the invention. Therefore, depending on the particular embodiment, the NRC entity may be considered to be either a physical device, and/or a software component that is stored in the computer readable media such as volatile or non-volatile memories of one or more communicating device(s) within the networked computing system 100.

In an embodiment of the invention, any of the network controller devices 110-114 and/or network base stations 106a-e may function independently or collaboratively to implement processes associated with various embodiments of the invention. Further, any of the processes for auditing and correcting base station antenna configuration may be carried out via any common communications technology known in the Art, such as those associated with modern Global Systems for Mobile (GSM), Universal Mobile Telecommunications System (UMTS), Long Term Evolution (LTE) network infrastructures, etc.

In accordance with a standard GSM network, any of the network controller devices 110-114 (NRC devices or other devices optionally having NRC functionality) may be associated with a base station controller (BSC), a mobile switching center (MSC), or any other common service provider control device known in the art, such as a radio resource manager (RRM). In accordance with a standard UMTS network, any of the network controller devices 110-114 (optionally having NRC functionality) may be associated with a network resource controller (NRC), a serving GPRS support node (SGSN), or any other common network controller device known in the art, such as a radio resource manager (RRM). In accordance with a standard LTE network, any of the network controller devices 110-114 (optionally having NRC functionality) may be associated with an eNodeB base station, a mobility management entity (MME), or any other common network controller device known in the art, such as an RRM.

In a wireless network, the number of UEs attached to a particular base station is a function of the number of active users in the base station's coverage area. If a large number of users are closer to a particular base station than its neighbors, the particular base station may have a larger number of UEs attached to it than its neighbors do, even though some of the UEs are within service range of the neighboring base stations.

In an embodiment, any of the network controller devices 110-114, the network base stations 106a-e, as well as any of the UE 108a-m may be configured to run any well-known operating system, including, but not limited to: Microsoft® Windows®, Mac OS®, Google®Chrome®, Linux®, Unix®, or any mobile operating system, including Symbian®, Palm®, Windows Mobile®, Google® Android®, Mobile Linux®, etc. In an embodiment of the invention, any of the network controller devices 110-114, or any of the network base stations 106a-e may employ any number of common server, desktop, laptop, and personal computing devices.

In an embodiment of the invention, any of the UE 108a-m may be associated with any combination of common mobile computing devices (e.g., laptop computers, netbook computers, tablet computers, cellular phones, PDAs, handheld gaming units, electronic book devices, personal music players, MiFi™ devices, video recorders, etc.), having wireless communications capabilities employing any common wireless data communications technology, including, but not limited to: GSM, UMTS, 3GPP LTE, LTE Advanced, WiMAX, etc.

In an embodiment, the backhaul portion of the data communications network 102 of FIG. 1 may employ any of the following common communications technologies: optical fiber, coaxial cable, twisted pair cable, Ethernet cable, and power-line cable, along with any other wireless communication technology known in the art. In context with various embodiments of the invention, it should be understood that wireless communications coverage associated with various data communication technologies (e.g., network base stations 106a-e) typically vary between different service provider networks based on the type of network and the system infrastructure deployed within a particular region of a network (e.g., differences between GSM, UMTS, LTE, LTE Advanced, and WiMAX based networks and the technologies deployed in each network type).

In an embodiment of the invention, any of the network controller devices 110a-c, the network base stations 106a-e, and UE 108a-m may include any standard computing software and hardware necessary for processing, storing, and communicating data between each other within the networked computing system 100. The computing hardware realized by any of the network computing system 100 devices (e.g., any of devices 106a-e, 108a-m, 110-114) may include: one or more processors, volatile and non-volatile memories, user interfaces, transcoders, modems, wireline and/or wireless communications transceivers, etc. Further, any of the networked computing system 100 devices (e.g., any of devices 106a-e, 108a-m, 110-114) may include one or more computer readable media encoded with a set of computer readable instructions, which when executed, can perform a portion of the functions associated with various embodiments of the invention.

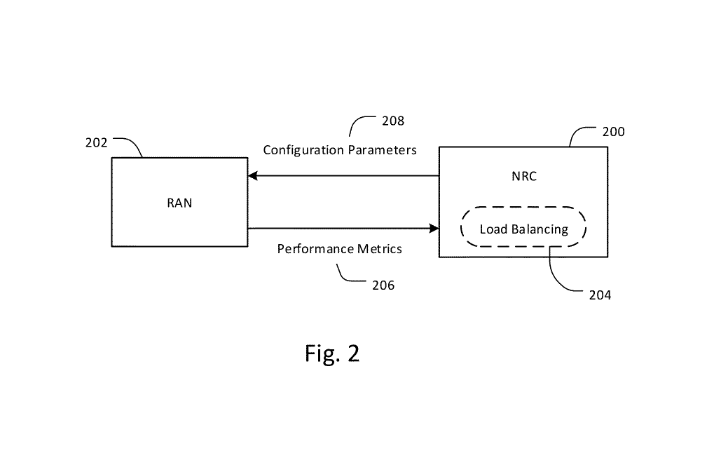

FIG. 2 shows an overview of a load balancing operation according to an embodiment of the present invention. In particular, FIG. 2 shows an NRC 200 interfacing with a radio access network (RAN) 202, which corresponds to the communications network 102, to implement a load balancing function 204. In an embodiment, an NRC 200 implements the load balancing function 204 and collects performance metrics 206 which may be radio key performance indicators (KPIs). The KPIs are translated to numerical metric values that allow the system to identify which radio-proximate cell clusters are acceptable candidates for load balancing.

During intervals in which a candidate cluster is poorly load-balanced, the antenna configurations in the cluster may be incrementally adjusted according to configuration parameters 208 to reduce the load on overloaded cells. During and following the configuration process, the KPIs may be monitored to ensure that coverage holes are not being created. At the conclusion of the overload interval, the original antenna configuration may be restored.

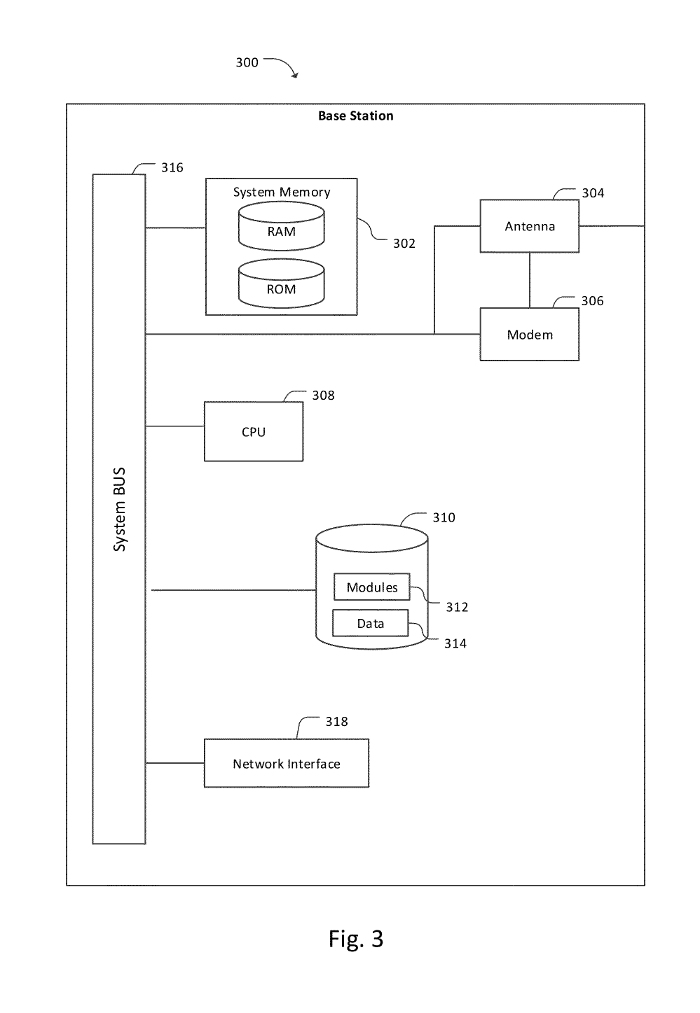

FIG. 3 illustrates a base station 300 according to embodiments of the invention. Base station 300 may be any base station 106 shown in FIG. 1.

The network base station 300 may also include one or more data processing devices including a central processing unit (CPU) 308. In an embodiment, CPU 308 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 308 may execute computer programs stored on the network base station's 300 volatile (RAM) and non-volatile (e.g., ROM) system memories 302, or in storage 310.

Storage 310 may comprise volatile or non-volatile memory such as RAM, ROM, a solid state drive (SSD), SDRAM, or other optical, magnetic, or semiconductor memory. In an embodiment, storage 310 includes one or more modules 312 and data 314. Data 314 may be data used by embodiments of the present invention, such as geo-location data and usage metrics. Module 312 may be a software module for performing one or more aspect of processes according to various embodiments, such as calculations to convert measured usage metrics to values used to calculate a load balancing metric.

The network base station 300 may also include a network interface component 318 that facilitates the network base station's 300 communication with the backhaul or wireless portions of the network computing system 100 of FIG. 1, a modem 306 for modulating an analog carrier signal to encode digital information and for demodulating a carrier signal to decode digital information, and a system bus 316 that facilitates data communications between the hardware resources of the network base station 300.

Base station 300 may include at least one antenna 304 for transmitting and receiving wireless communications to and from devices in wireless communication with the base station 300. In an embodiment of the invention, the base station antenna 304 may use any common modulation/encoding scheme known in the art, including, but not limited to Binary Phase Shift Keying, Quadrature Phase Shift Keying, and Quadrature Amplitude Modulation. Additionally, the network base station 300 may be configured to communicate with wireless equipment via any Cellular Data Communications Protocol, including any common LTE, LTE-Advanced, GSM, UMTS, or WiMAX protocol.

Antenna 304 may be associated with a plurality of parameters associated with characteristics of a cell, which may be evaluated and adjusted according to embodiments of the present invention. These parameters include beamwidth, boresight azimuth and downtilt.

Each base station may serve a number of carriers operating on different respective frequencies, and includes a number of antennas which each have a physical coverage area. As used herein, the term “cell” refers to an area served by a single antenna for a given carrier frequency. The coverage area of a cell may relate to the signal strength of a particular carrier signal, such that the boundaries of the cell are defined by points at which the signal strength drops crosses a threshold value, or by points at which the interference rises above a threshold value.

Each cell is served by a given base station, so when UE is described as being attached to a cell, it is also attached to the particular base station 300 associated with the cell. A single base station may serve a plurality of cells, each of which has a separate, and possibly overlapping, coverage area.

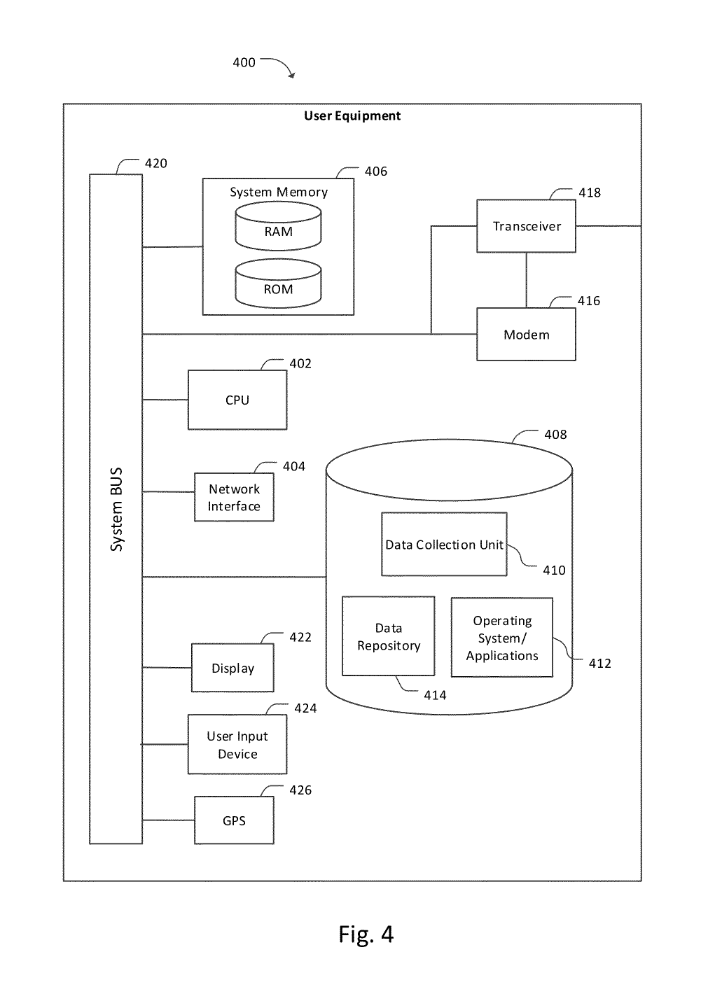

FIG. 4 illustrates user equipment (UE) 400 according to an embodiment of the present invention. UE 400 may include one or more data processing device such as central processing unit (CPU) 402. In an embodiment of the invention, the CPU 402 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 402 may be responsible for executing all computer programs stored on the user equipment's 400 volatile (RAM) and non-volatile (e.g., ROM) system memories 406 and storage 408.

UE 400 may also include a network interface component 404 that can facilitate communication between UE 400 and locally connected computing devices (e.g., a Personal Computer), a modem 416 for modulating an analog carrier signal to encode digital information and for demodulating a carrier signal to decode digital information, a wireless transceiver component 418 for transmitting and receiving wireless communications to and from a base station, a system bus 420 that facilitates data communications between hardware resources of UE 400, display unit 422 for displaying text or graphics information, a user input device 424 such as a keyboard, mouse, or touch-screen, GPS unit 426, and a storage 408. Storage 408 may include a data collection unit 410, an operating system/applications repository 412, and a data repository 414 storing various user equipment data.

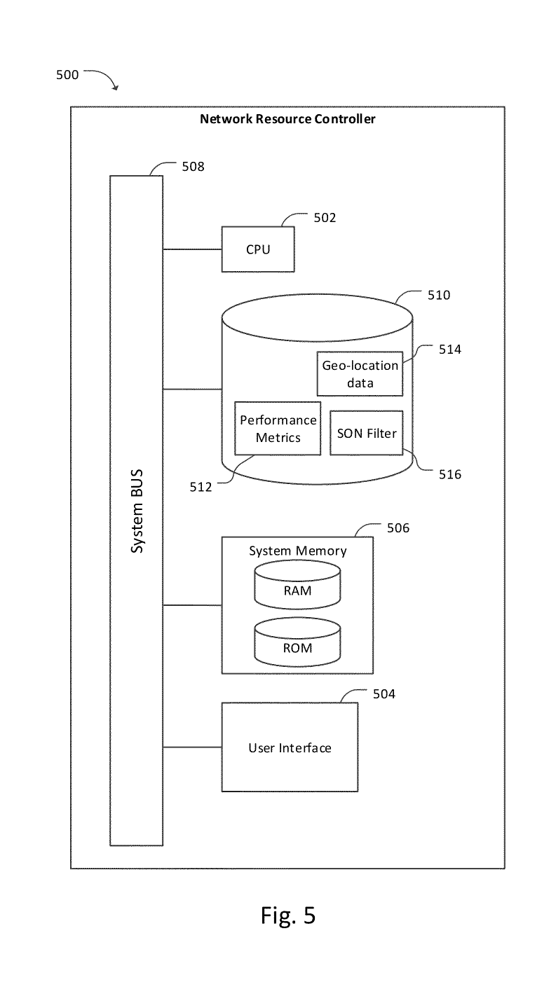

FIG. 5 shows a Network Resource Controller (NRC) 500 according to an embodiment of the present invention. In accordance with an embodiment of the invention, NRC 500 may be associated with any common base station or network controller device known in the Art, such as an LTE eNodeB (optionally comprising a wireless modem), RRM, MME, RNC, SGSN, BSC, MSC, etc. In an embodiment, NRC 500 is a Self-Organizing Network (SON) server.

NRC 500 may include one or more data processing device including a CPU 502. In an embodiment, CPU 502 may include an arithmetic logic unit (ALU, not shown) that performs arithmetic and logical operations and one or more control units (CUs, not shown) that extract instructions and stored content from memory and then execute and/or processes them, calling on the ALU when necessary during program execution. CPU 502 may be responsible for executing all computer programs stored on the NRC's 500 volatile (RAM) and non-volatile (e.g., ROM) system memories 506 and storage 510.

System memory 506 may comprise volatile or non-volatile memory such as RAM, ROM, a solid state drive (SSD), SDRAM, or other optical, magnetic, or semiconductor memory. Storage 510 may include data such as performance metrics 512, geo-location data 514, and one or more aspect of a SON pattern filter 516.

NRC 500 may include a network interface/optional user interface component 504 that can facilitate the NRC's 500 communication with the backhaul portion or the wireless portions of network computing system 100 of FIG. 1, and may facilitate a user or network administrator accessing NRC's 500 hardware and/or software resources. NRC 500 may also include a system bus 512 that facilitates data communications between hardware resources of NRC 500.

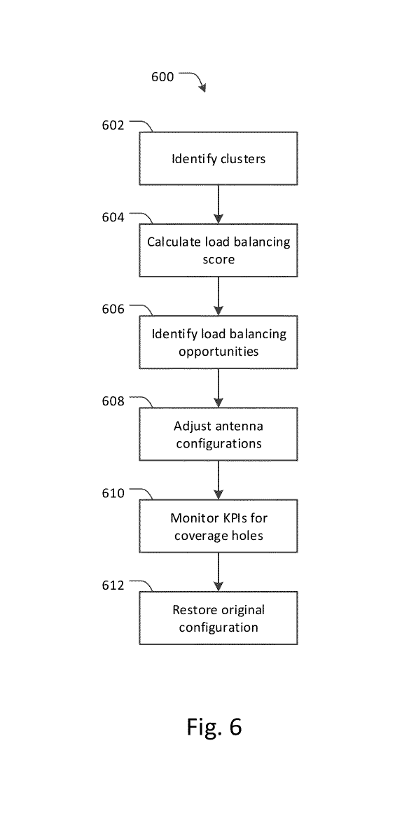

FIG. 6 shows a process 600 for load balancing according to an embodiment of the present invention. The process 600 in FIG. 6 is presented as a general overview to illustrate how an operator may implement various aspects of the present invention to balance a load in a cellular network.

As seen in FIG. 6, a cluster is identified in process 602. A system may use the network topology (e.g., base station antenna locations, terrain and clutter maps), configuration (e.g., antenna pointing configuration, transmit power), neighbor lists and KPIs to determine a set of logical cell clusters associated with each target cell. Each cell member of the cluster satisfies several conditions that determine whether it is a relevant neighbor to the target cell in the cluster. Process 602 may be performed any time prior to executing the remaining processes.

In process 604 the KPIs are examined to determine a load balancing score for the cluster. Clusters may be ranked by load balancing score, and those clusters whose score exceeds a threshold may be marked for possible subsequent load balancing processes.

In process 606 clusters whose scores exceed a predetermined threshold trigger load balancing action. In an embodiment, other trigger criteria may be applied to further restrict which clusters trigger load balancing action. For example, information may be processed by a SON filter to predict a recurring and long-duration target cell overload based on past KPI history. The SON filter may be applied to determine a probability of whether an overload condition will persist for sufficient time to implement additional load balancing processes.

In process 608, the clusters for which load balancing actions have been triggered have their antenna configurations adjusted while concurrently monitoring the KPIs to ensure that coverage holes are not created in process 610. In process 612 the load balancing opportunity ends and the cluster is returned to its original configuration. In an embodiment, successive load balancing operations may initiate with either of processes 602 or 604.

There are several possible ways for load balancing a cluster of cells. One set of techniques involves changing the relative coverage patterns amongst the cells, for example by adjusting the electrically steerable base station antenna pointing angles (downtilt, azimuth, beamwidth), adjusting the relative transmit powers between the cells, or both. Another method is to manipulate the UE handover cell selection criteria to induce terminals to shift to a new serving cell.

In all cases a load balancing algorithm may benefit from a prior determination of which cells belong to the cluster. The particular process used to identify a cluster may depend on the particular technique used for achieving load balance within the cluster. In an embodiment, the cluster members can be determined algorithmically to automate the process. In various embodiments, cluster identification may occur up-front during a network analysis phase for all cells in the network, or on-demand when a particular cell becomes overloaded.

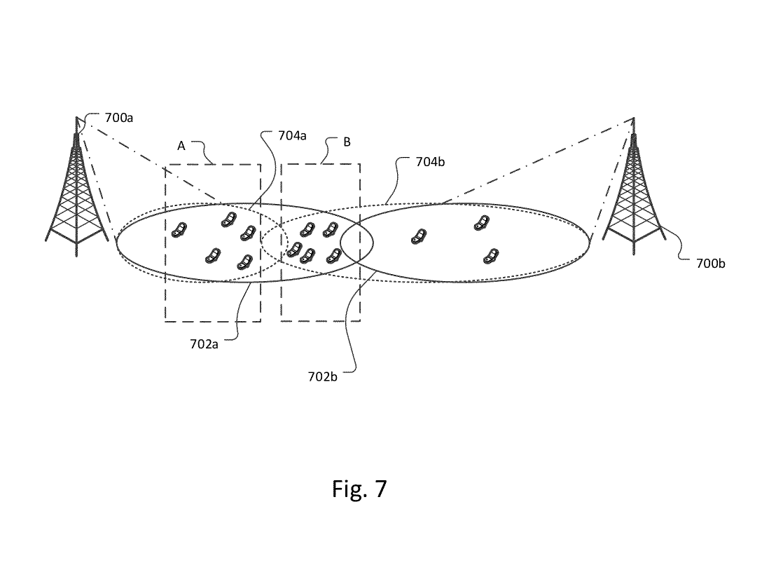

Some embodiments may use remote electrical tilt (RET) of clusters of antennas. An example of RET is illustrated in FIG. 7. A basic principle of using RET to balance a load is that the overloaded cell reduces its coverage area, and therefore its UE occupancy, by increasing the antenna downtilt while nearby cells simultaneously increase their coverage area by decreasing their antenna downtilt to cover UEs no longer served by the overloaded cell.

As seen in FIG. 7, neighboring base stations 700a and 700b are serving overlapping areas. In an original configuration, all of the UE 706 in both of group A and group B are being served by base station 700a in original cell 702a, resulting in an overload condition. Meanwhile, neighboring base station 700b is serving original cell 702b, which has unused capacity.

In an embodiment of a load balancing process using RET, the downtilt angle of an antenna of base station 700b is reduced (i.e., the antenna is tilted upwards) so that adjusted cell 704b covers UE in group B. In the same process, an antenna of base station 700a is tilted downwards so that it still provides service to the UE in group A through adjusted cell 704a. UE in group B now receive a better signal from base station 700b, so they are handed off from base station 700a to base station 700b, so that the wireless load is balanced between the base stations.

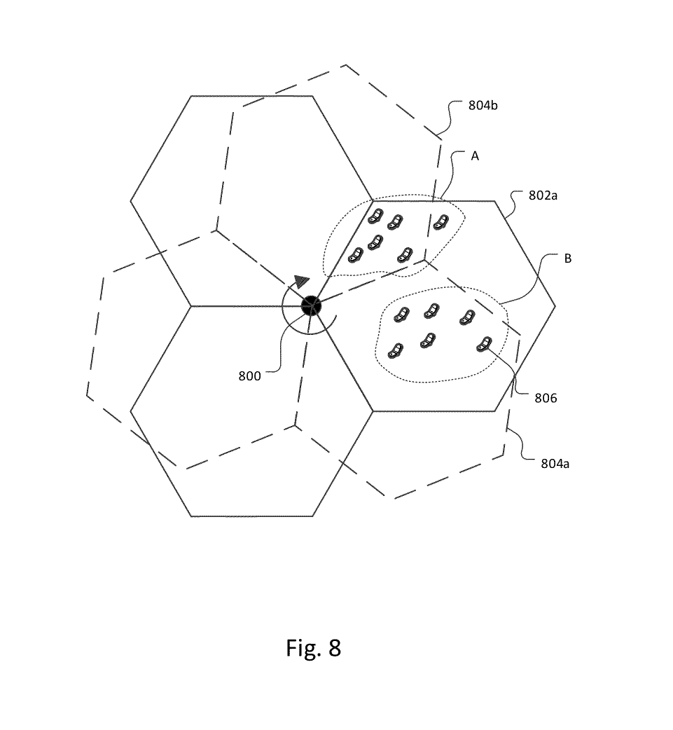

As illustrated by FIG. 8, another process of antenna adjustment involves rotating co-site cells about their common axis by manipulating their antenna azimuth settings through remote azimuth steering (RAS). Rotating the coverage areas of a cell can cause UEs near the borders with co-site cells to select a new co-site serving cell.

For example, as shown in FIG. 8, base station 800 serves three cells. UE of group A and group B are in original cell 802a. Antennas of base station 800 are rotated so that UE 806 of group A are covered by adjusted cell 804a, and UE of group B are covered by adjusted cell 804b. The UE of group B are handed off from the antenna of original cell 802a to the antenna of adjusted cell 804b in order to balance a cellular load.

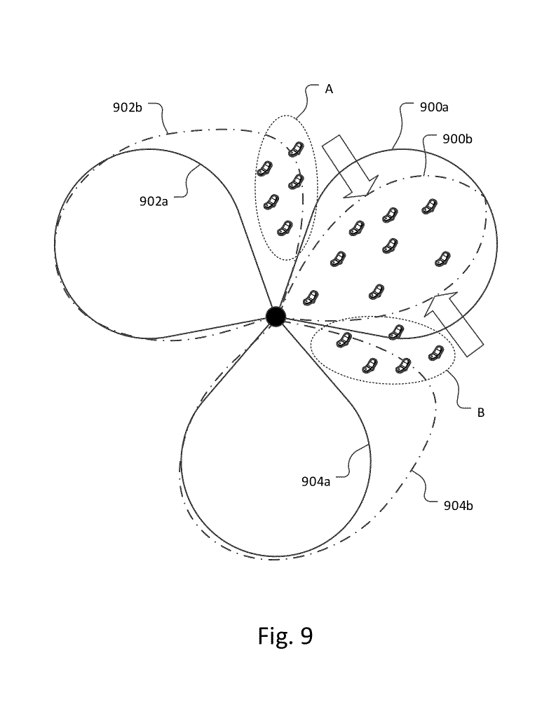

As shown in FIG. 9, a third process of antenna adjustment for load balancing involves manipulating the cell angular coverage, or antenna gain pattern beamwidth. In an embodiment, beamwidth is adjusted remotely using a Remote Antenna Beamwidth (RAB) adjustment. In an embodiment, the beamwidth of an overloaded target antenna serving cell 900 is narrowed from cell 900a to 900b, and the beamwidth of one or more co-site cells such as cells 902 and 904 with less of a load may optionally be enlarged. In another embodiment, narrowing the beamwidth of the target cell enlarges the coverage area of neighboring cells without making any adjustments to the neighboring antennas. A similar principle applies to embodiments using RET discussed above with respect to FIG. 7. Accordingly, in some embodiments, only the antenna serving the target cell is adjusted. As seen in FIG. 9, cell 902a is enlarged to become cell 902b, and cell 904a is enlarged to become cell 904b. UE are handed off from the narrowed target cell to the one or more enlarged cells to balance the load. In FIG. 9, UE of group A are handed off from narrowed cell 900b to enlarged cell 902b, and UE of group B are handed off from narrowed cell 900b to enlarged cell 904b.

In an embodiment, RAB adjustment is conducted in combination with cell rotation through RAS. The principle of a combined process is to reduce the coverage area of an overloaded target cell by narrowing the beamwidth while simultaneously broadening and rotating the co-site cells to fill the vacated coverage of the target cell.

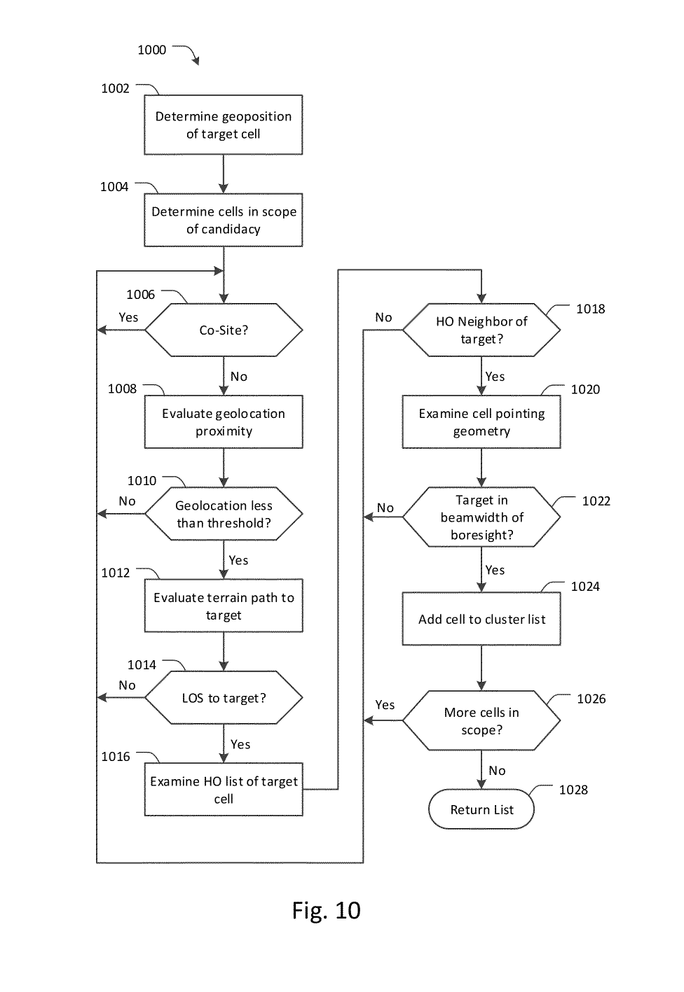

FIG. 10 shows an embodiment of a process 1000 for defining a cluster. The process 1000 of FIG. 10 may be used in an embodiment in which antennas are adjusted using RET such as the process illustrated in FIG. 7.

As shown in FIG. 10, defining a cluster may begin by a process 1002 for determining the geo-position of a target cell. In an embodiment, the geo-position is determined by a database lookup of geo-position data in an NRC. The geo-position may include geographical coordinates such as latitude, longitude, and elevation. In an embodiment, geo-position data may include height above terrain data.

The basis for the scope of candidacy for inclusion in the cluster is a set of one or more criteria for selecting cells that are likely to share radio coverage overlap with the target cell that can be modified via RET adjustment. In an embodiment, the scope is a geographical condition such as a radius from the target cell, such as five kilometers, or a metro service area. In some embodiments, the scope of candidacy may be defined by a user or an algorithm, and the scope may be determined as part of process 1004. In an embodiment, process 1004 of determining the cells within the scope of candidacy identifies all cells that satisfy the geographical condition, and the cells are further sorted through subsequent processes.

Process 1006 determines whether a cell in the scope of candidacy is co-site located with respect to the target cell. In an embodiment in which RET adjustment is the only type of antenna adjustment, cells that are co-site located with respect to the target cell (e.g. using the same radio transmission tower) may not be within the scope of candidacy because RET adjustments generally do not affect occupancy of UEs between them.

However, in another embodiment, co-site cells that share a common azimuth pointing with the target cell (e.g. stacked cells) may be included in the scope of the cluster. Accordingly, process 1006 may further include determining whether a co-site cell shares a common azimuth pointing with the target cell. In the case that the candidate cell is co-site with the target cell, process 1006 may proceed to examine the next cell in the scope of candidacy.

In process 1008, the distance proximity of the candidate cell to the target cell is evaluated, and in process 1010, it is compared to a threshold value. These processes may be performed in an embodiment in which the scope of candidacy was determined by a geographic area that is larger than a threshold value. For example, when the scope of candidacy is a metropolitan area with 100 square kilometers, the threshold value may be 5 kilometers, 2 kilometers, or another value that defines an area smaller than the area of process 1004.

In another embodiment, the threshold value may be determined separately for each target cell. In such an embodiment, the threshold value is proportional to the inter-cell distance. More specifically, a distance threshold may be determined by evaluating the average distance from the target cell to the nearest N number of non co-site cells and setting the distance threshold to a multiple of the average distance. Examples of N include 3, 5, and 10, and examples of multiples include 3 and 5. If the distance is greater than a threshold value the candidate cell is excluded from the cluster.

In process 1012, the terrain path between the target and candidate cells is evaluated. In an embodiment, this process may include evaluating topography maps stored on an NRC, or using planning tools which are accessible by the system. Process 1014 uses the evaluated terrain path to determine whether the candidate cell has a line of sight (LOS) to the target cell, and if no LOS is present, the candidate is excluded from the list.

In process 1016, the UE handover relationship is examined between the target and candidate cells. If configured neighbor relations or reported handover counts indicate that there is no UE mobility or low levels of UE mobility between the target cell and the candidate cell, then process 1018 determines that the candidate cell is not a neighbor of the target cell, and the candidate cell is not included in the cluster. In an embodiment, process 1018 excludes candidate cells that do not allow UE mobility either by network policy or some other reason and thus would not be suitable for load balancing.

The pointing direction (azimuth) of the candidate cell is examined in process 1020 to determine whether it is directed towards the target cell site. In process 1022, the candidate cell is evaluated to determine whether the target cell is within a threshold beamwidth value of the candidate. In an embodiment, the threshold beamwidth value is 3 dB, and other values are possible in other embodiments. Candidates for which the target cell is not within the threshold beamwidth value are excluded from the list.

If the cell meets the criteria of the subsequent processes and is RET capable it is added to the cluster set of cells in process 1024. In process 1026, if there are more candidate cells that have not been evaluated, process 1000 returns to process 1006 to evaluate remaining candidate cells until all cells in the scope have been processed. The end result is a list of cells that define the cluster of the target cell for antenna adjustment load balancing, which is stored in process 1028.

In some embodiments, other policy criteria in addition to those detailed in FIG. 10 are possible. In various embodiments, the order of steps in the flow diagram may be rearranged without significantly affecting the cluster determination outcome. Some embodiments may omit one or more of the processes shown in FIG. 10.

A process of determining the cluster for adjustment through RAS may begin with selecting a target cell based on its overload status. For example, a target cell may be selected based on comparing one or more KPI of the cell to a threshold value. Candidate cells for being included in the cluster may then be evaluated based on whether the cell shares a site with the target cell.

In a process of determining a cluster for load balancing operations that use RAB, a target cell is selected based on its overload status. Candidate cells may also be evaluated based on a set of criteria which includes whether the cell shares a site with the target cell. In some embodiments, a target cell is capable of all three antenna adjustment modes (RET, RAS, RAB), and is adjusted using all three modes. Such embodiments may combine any of the processes described above for defining a cluster as appropriate.

If a given cell is overloaded, the associated cluster of neighbor cells may or may not be well suited to reducing the load from the target. For example, if the overloaded target cell's neighbors are also overloaded there is no opportunity to load-share between them. Furthermore, one or more of the cells in the cluster may be temporarily unavailable (e.g. locked by another target cell and cluster). Accordingly, embodiments of the present invention may include a process for defining a numeric score for a given cluster to help evaluate whether a cluster is a good candidate for load balancing. In an embodiment, such a score corresponds to how asymmetrically balanced the cluster is.

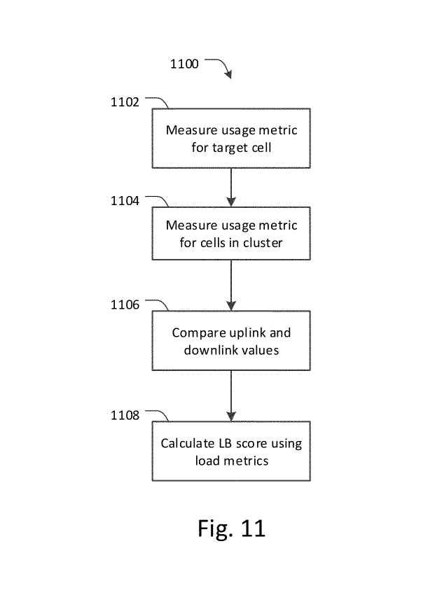

FIG. 11 illustrates a process 1100 of determining a load balancing metric for a cluster of cells according to an embodiment of the present invention. In process 1102, a usage metric is measured for the target cell. In process 1104, usage metrics are measured for each of the cells in the cluster.

The particular usage metrics measured in process 1102 may vary between different embodiments. Usage metrics may relate to the amount of load placed on a cell, the load on a cell relative to its overall capacity, or both, and may be KPI. For example, the metric may be the total amount of data transferred through a cell within a given period of time, which may be referred to as a load value of a cell. If the total amount of data transferred through the cell within a given period of time is divided by the maximum amount of data that a cell is capable of transferring during the time period, the resulting value may be referred to as a capacity value.

In general, bidirectional communication cells have distinct downlink and uplink values and an overload in one direction does not necessarily mean that the reverse link is also overloaded. Accordingly, in processes 1102 and 1104, separate estimations for the usage of the downlink and uplink may be evaluated. In such an embodiment, process 1106 is performed in which usage metrics, or values calculated from the usage metrics, for each of the uplink and downlink transmissions are compared. The smaller of the two usage metrics may be used in the calculation of the load balancing metric in process 1108. In another embodiment, process 1106 is performed after load balancing metrics have been calculated so that uplink and downlink scores are considered separately for various load balancing determinations.

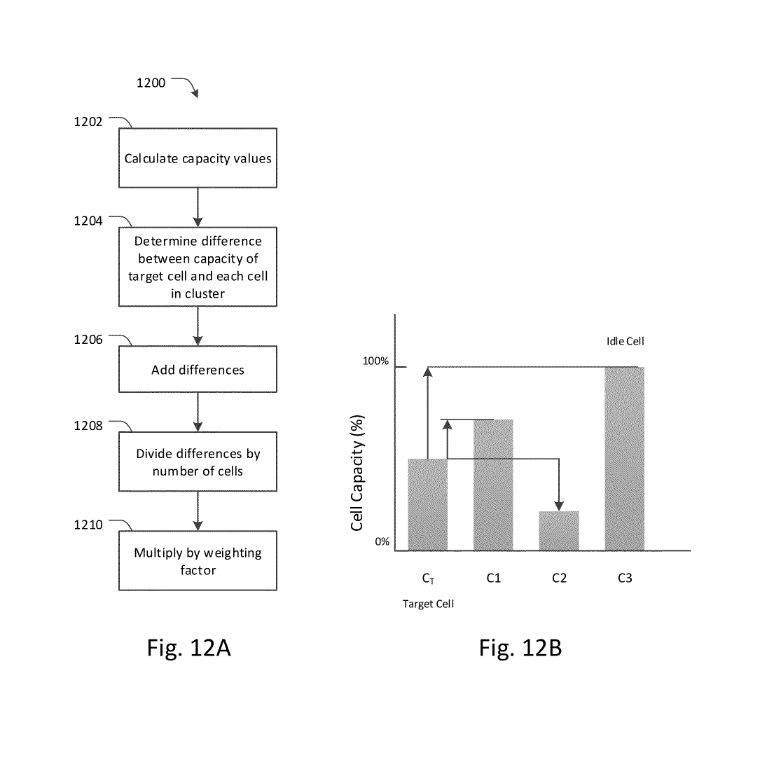

FIGS. 12A and 12B illustrate embodiments of a process for calculating a load balancing score. In process 1202, capacity values may be calculated based on the usage metrics measured in processes 1102 and 1104. For example, a capacity value may be calculated as the cell's throughput measured over a time period and divided by the maximum possible throughput for the cell.

In a process 1204, the difference between the capacity values of a target cell and the capacities for each cell in the cluster is determined. In process 1206, the differences from process 1204 are added, while in process 1208, the sum of the differences is divided by the number of cells in the cluster other than the target cell. Accordingly, processes 1204-1208 may be performed according to the following Equation 1:

$$LB Metric = \frac{{{\sum }_{i = 1}}^{N} ( {C}_{i} - {C}_{Target} )}{N} \qquad [ Equation 1 ]$$

In Equation 1, N is the number of cells in the cluster other than the target cell, C_{T} is a capacity value for the target cell, and Cᵢ is a capacity value for the i-th cell in the cluster other than the target cell. The capacity value may be a value of one or more usage metric, or a value derived from the one or more usage metric. In an embodiment, the capacity value is a cell's free capacity.

Although steps 1206-1210 have been described with respect to a simple averaging function, embodiments of the present invention are not limited thereto. In other embodiments, other statistical values may be calculated for the group of differences. For example, in an embodiment, a median value may be calculated, while another embodiment calculates a root mean square (RMS) value. Persons of skill in the art will recognize that other statistical values are possible in other embodiments.

In an embodiment, a cell's free capacity is the cell's remaining capacity to serve additional traffic to active UE using the cell. Because a cell's absolute capacity depends on many factors including the geometry of the UE positions, the free capacity may be determined referenced to a profiled peak aggregate throughput of the cell over many combinations of UE types, positions and occupancy. For example, the aggregate throughput can be sampled over a period of time for a cell during peak busy intervals and the peak throughput for the cell defined as the 95^{th} percentile of the samples. In another embodiment, the peak throughput can be set by policy based on known capabilities of the cell.

The load balancing score for the cluster in an embodiment may be further conditioned based on the occupancy of the target cell. For example, the score may be multiplied by a weighting factor W normalized [0,1] relative to a predetermined maximum occupancy (e.g. 20 UEs). Similar weighting factors may be used to account for occupancy in other embodiments. Although embodiments according to FIGS. 12A and 12B have been described with respect to the used capacity of the cell, it should be understood that other metrics related to cell loading (e.g. the unused capacity of the cell) or combinations of metrics could be used to determine a load balancing score for the cluster in various embodiments.

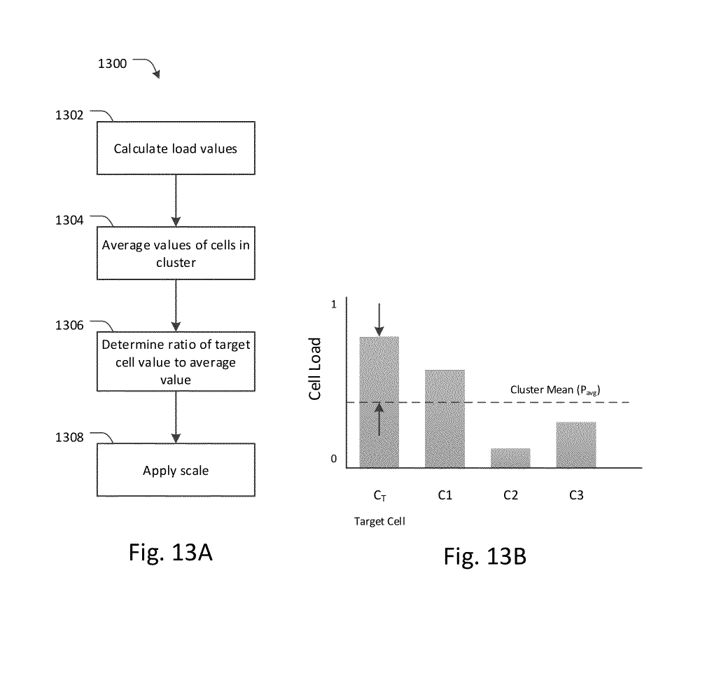

FIGS. 13A and 13B illustrate additional embodiments of a process 1108 for calculating a load balancing score. In the embodiments of FIGS. 13A and 13B, the load balance condition of the cluster is determined by examining a load on a target cell compared with its neighbors in a cluster of cells.

In one embodiment, the load balancing score is based on the cell active-UE-occupancy. In another embodiment the load balancing score is based on one or multiple fractional usage metrics corresponding to finite resources that potentially limit the cells ability to serve traffic to UEs.

A process 1300 for calculating a load balancing score may begin with a process 1302 of calculating load values. Process 1302 may include performing further calculations on the measured usage metrics to derive a load value. In another embodiment, the usage metric is the load value, and process 1302 is not performed.

In process 1304, an average of the load values for all of the cells in a cluster is calculated. The average value may or may not include the load value of the target cell. In process 1306, a ratio of the load value of the target cell to the average value is determined. In process 1308, the ratio may be scaled to a configured maximum value so that the score varies over the interval [0, 1]. The greater the load value of the target cell from the mean the larger is the load balance score, indicating a cluster with greater potential performance benefit from load balancing.

An embodiment of processes 1304-1308 is expressed in the following Equation 2:

LB Score=MIN((P_{T}/P_{avg})/Pₘₐₓ,1) [Equation 2]

In Equation 2, P_{T} is the load value of the target cell, P_{avg} is the average of load values in the cluster, and Pₘₐₓ is weighting factor used to normalize the ratio (P_{T}/P_{avg}) based on the upper bound of P_{T} and lower bound of P_{avg}.

Although the embodiments of process 1108 have been discussed with respect to capacity values for FIGS. 12A and 12B and with respect to load values for FIGS. 13A and 13B, embodiments of the present invention are not so limited. For example, an embodiment may consider an average of capacity values, or summed differences of load values.

The load balancing score for the cluster may be used to qualify action for load balancing the cluster. In one embodiment the scores that exceed a threshold value are used to trigger load balancing manipulation of cell antenna configurations. Once a cluster is load balanced, load balancing scores have additional utility in determining whether the cluster should be rebalanced or returned to original configuration.

If a particular target cell is overloaded and an associated cluster of neighbor cells that could be used to distribute a fraction of the overload is available, the question still remains whether or not the system should take corrective action. For example, the overload condition might be brief and resolve itself quickly without any intervention. In addition, the load balance methods described here have some associated risk of opening coverage holes and further that detection of problems may not be immediate. For these reasons, embodiments of the present invention may identify at the outset of an overload scenario how likely the overload is to persist and what the expected overload duration would be, barring intervention.

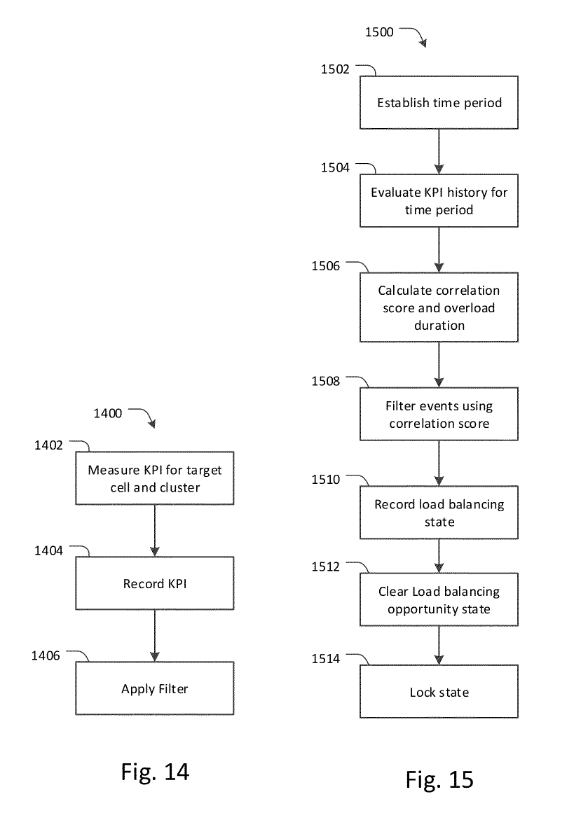

A process of assessing the relative value of a load balance opportunity predicts, based on network operation history, the likelihood that the overload will persist for a significant length of time adequate to adjust and monitor the performance benefits from cell coverage reconfiguration in a cluster of cells. An embodiment of such a process 1400 is illustrated in FIG. 14.

In a process 1402, KPI associated with load balancing conditions are measured by one or more network equipment such as a base station or NRC. Examples of KPI that may be measured in process 1402 include an overload condition, the amount of information exchanged between an antenna and UE in a cell, a percentage of the capacity of a cell that is used for uplink and downlink transmissions, etc. In embodiments, the KPI may be usage metrics discussed above, and may be referred to as load balancing metrics. In process 1404, the KPI are recorded by network equipment such as a base station or an NRC.

Whenever a cell becomes overloaded, the load balance metric history of values is examined to determine the likelihood that the overload is repetitive and will persist for a specified duration. The likelihood of a repetitive and persistent load balance opportunity is assessed by a process 1406 of applying a correlation filter to the load balance history database for a particular target cell and associated cluster.

An embodiment of a process 1500 of analyzing data using a filter will now be explained with reference to FIG. 15. The filter output detects correlated repeating patterns via a set of programmatic filter taps that are configured to correspond to typical repeating network usage intervals. Accordingly, in a process 1502, a time period corresponding to a repeating network usage interval is determined. Examples of time periods include one day, one week, weekdays or weekends within a week, etc.

The process of applying a filter 1500 includes a process 1504 of evaluating the KPI history over the time period. In process 1504, the duration of the overload event is determined by consecutive sequences of correlated reporting intervals. In process 1506, the filter outputs a correlation score and a probable duration of the overload event. In process 1508, the correlation score is then used to filter out those overload events that are likely to have occurred previously and are likely to persist for a predetermined time. In an embodiment, the predetermined time may be as little as 10 minutes or as long as one or more hours.

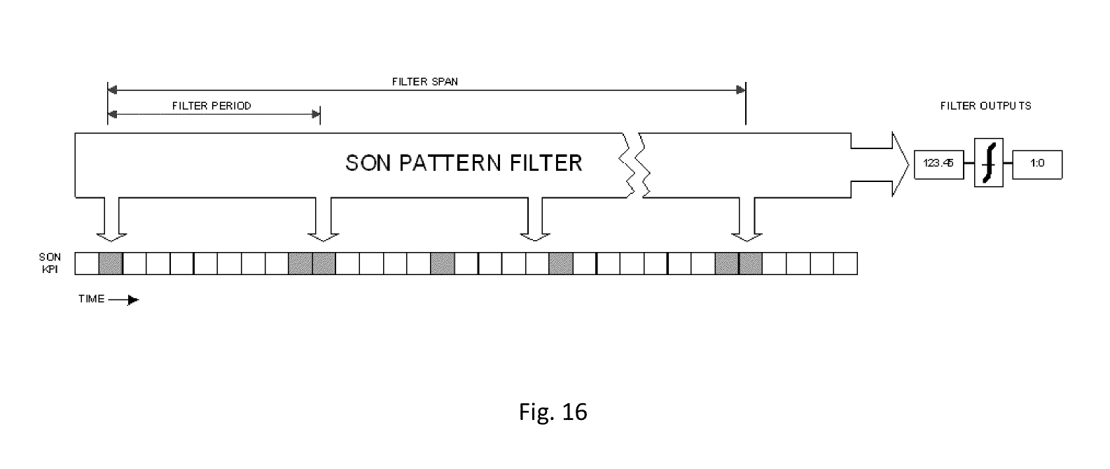

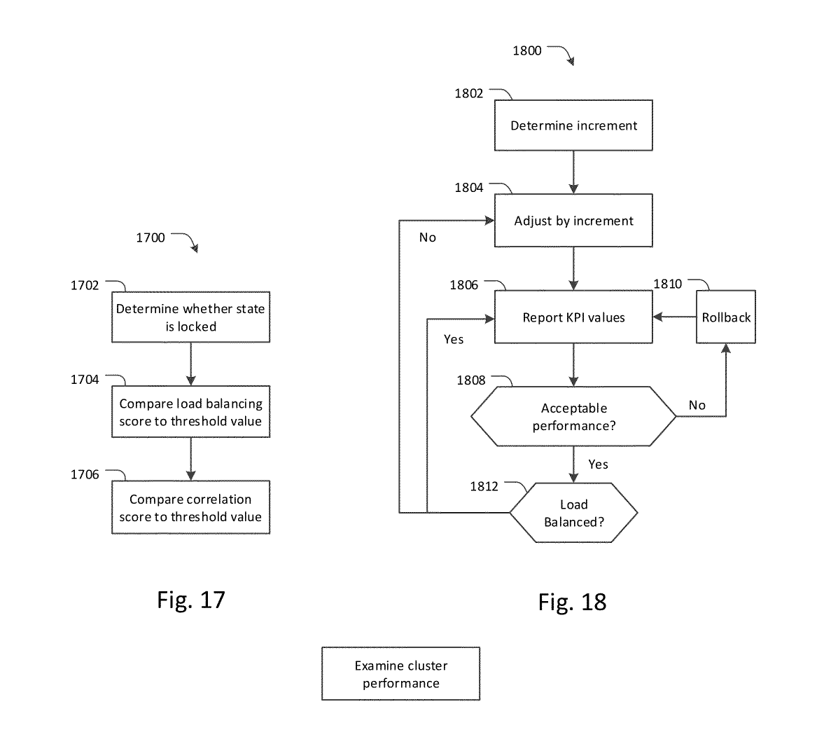

FIG. 16 is provided to illustrate an example of a filter according to an embodiment of the present invention. In addition, the following items are a non-exhaustive list of examples of various filter inputs that may be used in an embodiment. The list is given as an example only, and embodiments are not limited thereto. Examples of inputs include:
1) uniqueMetricID—the database name of the metric to correlate over time.
2) minMetric—the minimum value for the metric to be considered Boolean true, if lower then false.
3) maxMetric—the maximum value for the metric to be considered Boolean true, if greater then false.
4) samplingInterval—the time in minutes between KPI reports (e.g., 15 minutes), positive integer.
5) maxIntervals—the number of consecutive sampling intervals per filter tap that must exceed metric threshold for 100% correlation, positive integer.
6) tapinterval—the number of sampling intervals between filter taps, positive integer.
7) maxTaps—the number of filter taps (time span of the filter looking back in time).
8) minCorrelationScore—the minimum average score for a consecutive set of sampling intervals to be considered correlated (used to determine the max sampling interval duration of correlation).

The following items are a non-exhaustive list of examples of various filter outputs according to an embodiment of the present invention:
1) correlationScore—the ensemble average correlation [0,100]% of the specified filter for the metric over earliest maxInterval span.
2) correlationHist—the histogram by sampling interval bins of the correlationScores, 1×tapInterval array of scores [0,100]%.
3) maxCorrelationSpan—the maximum number of correlated sampling intervals, positive integer (0 . . . tapInterval).

Based on the explanation above, it should be apparent that a correlation filter provides a way for determining when a particular target cell and cluster is likely to have repeating and persistent load balance opportunities. If the correlation score exceeds a threshold value, load balance action may be taken that reduces the load imbalance of the target cell and cluster and thus, that affects the load balance metrics for those cells during the opportunity.

Returning to FIG. 15, the state of active load balance management of the target cell and cluster is recorded in process 1510 so that the correlation filter may account for this information when determining the correlation score. For example, in an embodiment, the correlation filter may ignore the period of time of active load balance management for the cells in the cluster that is being load balanced. In another embodiment, data from cells during the active load balancing time is evaluated separately from data during non-load balancing times.

In an embodiment, the separate evaluation of load balancing time may include evaluating the efficacy of the load balancing operation. For example, if cell occupancy is less than an overload condition but still exceeds a threshold value, the load balancing operation may not be performing adequately. In such an embodiment, predetermined antenna adjustments may be recalculated to improve the performance of the accounted load balancing operation.

Once a target cell and cluster is under active load balance management for the identified opportunity, it will remain in that state during successive predicted opportunities until such time when one or more measurement intervals indicate that load balancing is no longer required during the opportunity. On reaching this event, in process 1512 a portion or the entirety of the LB opportunity state may be cleared which causes the correlation filter to begin searching anew for repeating and persistent load balance opportunities for the target cell and associated cluster cells. In addition, in a process 1514, in order to prevent deadlocks between overlapping clusters, once a target cell and its cluster is under active load balance management its state is marked, or locked, so that no other target cell and cluster that might have overlapping cells can affect the configuration of the shared cells.

Although process 1500 has been described in a particular order, embodiments of the present invention are not limited by this order. In embodiments, various sub-processes of FIG. 15 may be performed at various times in a different order, or not performed at all.

Embodiments of the present invention may include a process 1700 of determining whether to perform a load balancing operation. Process 1702 is determining whether a load balancing state has been locked, for example in process 1514. If the state is locked, then no load balancing is performed. In process 1704, the load balancing score calculated in process 1100 is compared to a threshold value. If the load balancing score exceeds the threshold value, then a load balancing opportunity is present and load balancing is performed.

In an embodiment, process 1706 of comparing the correlation score output from a correlation filter to a threshold value may be performed. If the correlation score exceeds a threshold value, then load balancing may be performed for the time periods for which the score is exceeded.

Once a particular target cell and associated cluster are selected for load balance action the relative cell coverage in the cluster are adjusted. Examples of various antenna adjustments are RET, RAS, RAB, and adjusting transmission power. In an embodiment, the antenna configuration is performed in incremental steps using reported KPI feedback to assess whether the cluster has become sufficiently load-balanced, or the cluster performance is degrading (e.g. coverage hole detection) and load balancing should be aborted.

FIG. 18 illustrates a process for adjusting antennas according to an embodiment of the present invention. In a process 1802, an increment value for incremental antenna adjustments is determined. In an embodiment, the increment value is one degree of arc. An increment of one-degree steps could be used to gradually move towards load balance conditions while reducing the risk of significantly decreasing the coverage and capacity performance of the cluster before detecting the problem. In other embodiments, the increment may be less than one degree, two degrees, five degrees, etc. If load balancing is applied on an as-needed basis, smaller increments may be used, while if a load balancing pattern is established over time, larger increments may be used.

After an increment is established, an incremental adjustment 1804 of one or more of the antennas within the cluster is performed with the aim of restoring load balance between the cells in the cluster. For example, in the case of RET load balance this is accomplished by a further downtilt of the overloaded target cell (reducing its coverage area) and uptilt (decreased downtilt) of the cells best able to accept UEs from the target cell in order to level the cluster imbalance. In various embodiments, similar incremental adjust/monitor strategies may be employed for other processes of load sharing using combinations of RET, RAS and RAB antenna adjustments or transmit power.

RAN performance KPIs are reported periodically in process 1806 to derive the numeric scores that reflect the load balance condition and cluster performance. In an embodiment, the KPIs may indicate coverage and/or capacity. The cluster performance is examined in process 1808 and if there is a large negative shift or a trend of negative shifts the algorithm may rollback the antenna configuration to the previous setting in process 1810 before again looping to collect more KPI reports. If the cluster performance remains stable, the state of the load balance in the cluster is examined in process 1812. If the examination determines that further adjustment is required, the process 1800 may loop back to process 1804 of incrementally adjusting, or in another embodiment the process continues to monitor most recent KPI reports according to process 1806.

One example of how KPIs reported in process 1806 may be related to the overall cluster performance which may be used in process 1808 uses metrics from which the presence of coverage holes can be inferred. For example, call/session drop ratios and handover success ratios would increase if mobile UEs traverse areas of poor coverage. Other types of metrics such as trends in active UE terminal occupancy and throughput performance for the cluster can also be used to assess whether coverage issues are emerging as the cluster area coverage is adjusted towards load balance.

As the cluster antenna configuration is adjusted, process 1812 assesses whether optimal load balance has been achieved whereupon no further adjustments are needed. Various criteria for this assessment are possible. For example, various load balance metrics discussed above may be compared to a threshold value below which no further load balance action is required.

Alternatively, if available the UE throughput statistics can be used in a cumulative distribution function (CDF) to identify the optimum antenna configuration such as where the median UE throughput is maximal for the cluster. In another embodiment, the load may be balanced using the active UE cell occupancy as the primary metric which assumes each active UE is approximately equal in terms of it offered network load.

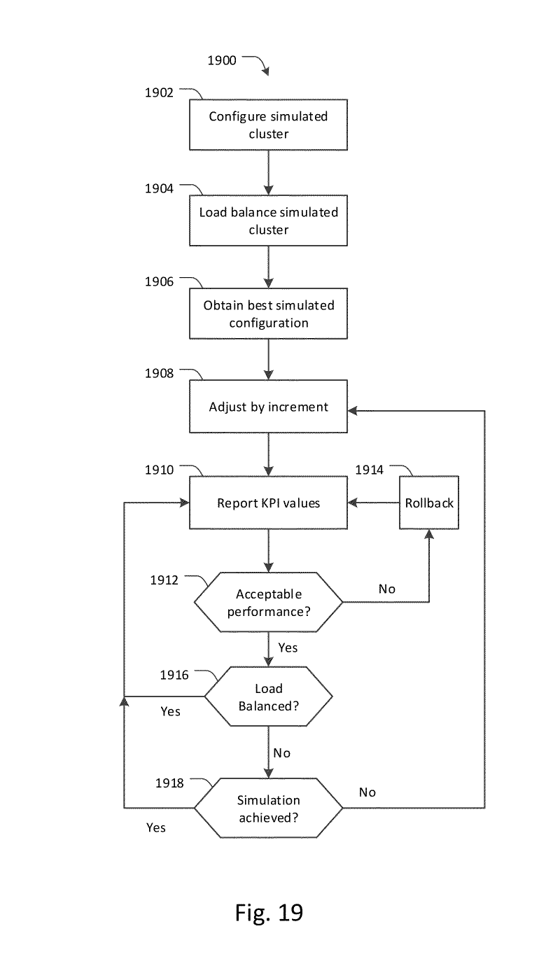

As illustrated by process 1900 in FIG. 19, in another embodiment, a radio coverage prediction engine, which may be integrated with an NRC or an external platform, is first used to optimize the load for a portion of a radio network that includes the unbalanced cluster of cells. The coverage prediction takes place in real time and is triggered by the overload event. The prediction engine may be seeded with the active number of UEs per cell based on exiting KPI reports and the starting antenna configuration. If it is available, the prediction may accept the positions and/or throughputs of the UEs relative to the cell sites as an input. In another embodiment, UE position and throughput data may be randomly assigned.

The prediction engine uses standard optimization techniques (e.g. simulated annealing) to load balance the cluster using the cluster antenna configuration as the variable parameter. In an embodiment, the resulting predicted optimum antenna configuration is used as one of the endpoint conditions for the configuration control loop.

A process 1900 of antenna adjustment in a load balancing operation begins when a cluster load imbalance is detected. In a process 1902, the radio coverage prediction engine is seeded with the active terminal occupancy and position and throughput parameters if available. In embodiments, the data seeded in process 1902 may be historical data or current data. In another embodiment, these values are randomly assigned.

In process 1904, the radio coverage prediction engine is used to generate a series of estimations driven by standard optimization methods and an objective function satisfying both a cluster load balance criteria such as the criteria used to perform step 1812 and a minimum grid coverage criteria. In an embodiment, the prediction engine may be embodied as an API in an NRC. In process 1906, an optimal antenna configuration that achieves the optimization goals is determined from the load balance simulation of process 1904. In an embodiment, if no solution is discovered, the control loop may default to an embodiment such as the embodiment of FIG. 18 discussed above without simulation.

Next, processes 1908 is performed to adjust an antenna. However, in contrast to step 1804 of process 1800, when a configuration has been output in process 1906, the increments in antenna configuration are stepped between the beginning and endpoint settings rather than heuristically.

If no configuration is available, then process 1908 may use incremental adjustments similar to process 1804. An example of adjustments that may be made in process 1908 are the simultaneous RET downtilt of a target cell and RET uptilt of a neighbor cell. Processes 1910, 1912, 1914, and 1916 correspond to processes 1806, 1808, 1810, and 1812, respectively, which are explained above. In an embodiment, after adjusting one or more antenna, the configuration is checked against the endpoint in process 1918 and stops further adjustment once it is reached.

A limitation of upfront simulation is the use of a radio coverage prediction engine, prediction engine configuration, increased processing complexity and the latency introduced while attempting to find an optimal simulated load balance condition. It is also possible that because of differences in the simulated and actual network radio environment the simulated load balance configuration for the cluster antennas may not match reality which might lead the system to stop hunting for the load balance condition before it is reached. However, advantages of upfront simulation is greater assurance that coverage holes will not be created in the actual network which reduces the importance of after-the-fact detection with KPI feedback, and it may operate more quickly than an embodiment that uses small increments. Depending on the available computing resources for simulation, the additional latency is unlikely to be a factor in an actual system assuming that the KPI reports are available at time intervals that are longer than the simulation time.

What is claimed is:

1. A system for determining a load balancing metric for a cluster of cells in a cellular network and performing load balancing using the load balancing metric, the system comprising:
a processor; and
a non-transitory computer readable medium with computer executable instructions stored thereon which, when executed by the processor, perform the following method:
defining a cluster of cells including a target cell that is a target for a load balancing operation and a plurality of nearby cells;
measuring a usage metric for the target cell;
measuring usage metrics for remaining cells in the cluster; and
calculating the load balancing metric using the usage metric value for the target cell and the usage metric values for the remaining cells in the cluster.

2. The method of claim 1, wherein calculating the load balancing metric further comprises:
calculating a capacity value for each cell in the cluster including the target cell based on the usage metric for each respective cell;
determining a plurality of differences between the capacity value for the target cell and the capacity values for each of the plurality of nearby cells; and
calculating a statistical value based on the plurality of differences.

3. The system of claim 2, wherein the non-transitory computer readable medium with computer executable instructions stored thereon further includes instructions which, when executed by the processor, cause the processor to multiply the statistical value by a weighting factor normalized relative to a predetermined maximum occupancy.

4. The system of claim 2, wherein the capacity value is determined with respect to a profiled peak aggregate throughput of the cell.

5. The system of claim 2, wherein calculating the load balancing (LB) metric is performed according to the following equation:
$$LB Metric = \frac{{{\sum }_{i = 1}}^{N} ( {C}_{i} - {C}_{Target} )}{N}$$
in which C_{Target} is the free capacity metric for the target cell, Cᵢ is the free capacity metric for an i-th cell in the cluster not including the target cell, and N is a number of cells in the cluster not including the target cell.

6. The system of claim 1, wherein calculating the load balance comprises:
calculating an average of the capacity metric values for the remaining cells in the cluster; and
calculating a ratio between the free capacity metric for the target cell and the average of the capacity metric values for the remaining cells.

7. The system of claim 6, wherein the non-transitory computer readable medium with computer executable instructions stored thereon further includes instructions which, when executed by the processor, cause the processor to scale the ratio to a configured maximum value so that the metric varies over the interval [0, 1].

8. The system of claim 1, wherein the usage metric for the target cell and the usage metrics for the remaining cells in the cluster are separately measured for uplink and downlink transmissions, and
wherein the method executed by the processor further comprises comparing the uplink usage metrics to the downlink usage metrics, and using the smaller of the uplink usage metrics and the downlink usage metrics to calculate the load balancing metric.

9. The system of claim 1, wherein the load balancing metric is compared to a threshold value; and a load balancing operation is performed on the target cell when the load balancing metric exceeds the predetermined value.

10. The system of claim 9, wherein the load balancing metric is compared to a threshold value during a load balancing operation, and an antenna serving the target cell is returned to an original configuration when the load balancing metric does not exceed the threshold value.

11. A method for determining a load balancing metric for a cluster of cells in a cellular network, the method comprising:
defining a cluster of cells including a target cell that is a target for a load balancing operation and a plurality of nearby cells;
measuring a usage metric for the target cell;
measuring usage metrics for remaining cells in the cluster; and
calculating the load balancing metric using the usage metric value for the target cell and the usage metric values for the remaining cells in the cluster.

12. The method of claim 11, wherein calculating the load balancing metric further comprises:
calculating a capacity value for each cell in the cluster including the target cell based on the usage metric for each respective cell;
determining differences between the capacity value for the target cell and the capacity values for each of the plurality of nearby cells; and
calculating a statistical value based on the plurality of differences.

13. The method of claim 12, further comprising:
multiplying the statistical value by a weighting factor normalized relative to a predetermined maximum occupancy.

14. The method of claim 12, wherein the capacity value is determined with respect to a profiled peak aggregate throughput of the cell.

15. The method of claim 12, wherein calculating the load balancing (LB) metric is performed according to the following equation:
$$LB Metric = \frac{{{\sum }_{i = 1}}^{N} ( {C}_{i} - {C}_{Target} )}{N}$$
in which C_{Target} is the free capacity metric for the target cell, Cᵢ is the free capacity metric for an i-th cell in the cluster not including the target cell, and N is a number of cells in the cluster not including the target cell.

16. The method of claim 11, wherein calculating the load balance comprises:
calculating an average of the capacity metric values for the remaining cells in the cluster; and
calculating a ratio between the free capacity metric for the target cell and the average of the capacity metric values for the remaining cells.

17. The method of claim 11, wherein the usage metric for the target cell and the usage metrics for the remaining cells in the cluster are separately measured for uplink and downlink transmissions, and
wherein the method further comprises comparing the uplink usage metrics to the downlink usage metrics, and using the smaller of the uplink usage metrics and the downlink usage metrics to calculate the load balancing metric.

18. A non-transitory computer readable medium with computer executable instructions stored thereon which, when executed by the processor, perform the following method:
defining a cluster of cells including a target cell that is a target for a load balancing operation and a plurality of nearby cells;
measuring a usage metric for the target cell;
measuring usage metrics for remaining cells in the cluster; and
calculating the load balancing metric using the usage metric value for the target cell and the usage metric values for the remaining cells in the cluster.

19. The non-transitory computer readable medium of claim 18, wherein calculating the load balancing metric further comprises:
calculating a capacity value for each cell in the cluster including the target cell based on the usage metric for each respective cell;
determining differences between the capacity value for the target cell and the capacity values for each of the plurality of nearby cells; and
calculating a statistical value based on the plurality of differences.

20. The non-transitory computer readable medium of claim 18, wherein
calculating the load balancing metric further comprises:
calculating an average of the capacity metric values for the remaining cells in the cluster; and
calculating a ratio between the free capacity metric for the target cell and the average of the capacity metric values for the remaining cells.
